(19) United States
(12) Patent Application Publication
(10) Pub. No.: US 2024/0246291 A1
(43) Pub. Date: Jul. 25, 2024

(54) Laminates and 3D Printers

(71) Applicant: VICI TRANSITION, INC.,, Gig Harbor, WA (US)

(72) Inventor: Amos Gottlieb, San Francisco, CA (US)

(73) Assignee: VICI TRANSITION, INC.,, Gig Harbor,, WA (US)

(21) Appl. No.: 18/560,014

(22) PCT Filed: Jun. 24, 2022
(86) PCT No.: PCT/US2022/034999

§ 371 Date: Nov. 9, 2023

Related U.S. Application Data
(60) Provisional application No. 63/214,265, filed on Jun. 24, 2021.

(51) Int. Cl. B29C 64/245; B29C 64/124; B33Y 30/00; C08J 7/04; C08J 7/043; C09D 127/18

(52) U.S. Cl. CPC B29C 64/245; B33Y 30/00; C08J 7/042; C08J 7/043; C09D 127/18; B29C 64/124; C08J 2323/20; C08J 2427/18

(57) ABSTRACT

Laminates which are useful as windows in 3D printers. The laminates comprise three or more polymeric layers, including upper and lower layers comprising a fluoropolymer, for example tetrafluorethylene, and an intermediate layer composed of a non-elastomeric polymer, for example a polymer of 4-methyl-1-pentene.

### CROSS REFERENCE TO RELATED APPLICATIONS

This application is a national stage application, filed under 35 USC § 371, of International Application PCT/US22/34999 for “Laminates and 3D Printers,” filed Jun. 24, 2022, which is incorporated by reference herein in its entirety, which claims the benefit of and priority from U.S. provisional application 63/214,265, filed by Amos Gottlieb on Jun. 24, 2021.

This application is related to U.S. Provisional Application No. 62/950,072, filed Dec. 18, 2019, and to International Application No. PCT/US20/66252, filed Dec. 18, 2020, claiming priority from U.S. provisional application No. 62/950,072. The entire contents of each of U.S. Provisional Application No. 62/950,072, U.S. Provisional Application No. 63/214,265 and International Application No. PCT/US20/66252 are incorporated by reference in this application for all purposes.

### STATEMENT REGARDING FEDERALLY SPONSORED RESEARCH OR DEVELOPMENT

None.

### BACKGROUND

### Field of the Invention

This invention relates to novel polymeric laminates and 3D printers using the novel laminates.

### Description of the Related Art

Several types of 3D printers make use of a film or sheet having desired permeability characteristics. Some types of 3D printer, e.g. CLIP printers (CLIP being an abbreviation for Continuous Liquid Interface Production or Continuous Liquid Interface Printing), DLP printers (3D printers which are based on a digital light projector or digital light processor), DLV printers (3D printers which are based on a digital light valve) and some SLA 3D printers require or can benefit from the use of a film or sheet which is permeable to oxygen. Some other types of 3D printer can benefit from, or require the use of, a film or sheet which can be, but is not necessarily, permeable to oxygen. For a description of some 3D printers, reference may be made to U.S. Pat. Nos. 9,200,678, 9,211,678, 9,636,873, 9,486,964 and 10,016,938, the entire contents of which are incorporated herein by reference for all purposes.

International Application No. PCT/US20/66252 discloses a laminate which consists of two layers, namely
(1) a first layer which transmits light and is composed of a first polymeric composition, the first polymeric composition being a single polymer or a mixture of polymers, the polymer or at least one of the polymers preferably being a non-elastomeric polymer and preferably having a glass transition temperature of at least 0° C., for example a PMP polymer as defined in the International Application, and
(2) a second layer which transmits light, which adheres to the first layer and which is composed of a second polymeric composition, the second polymeric composition being a single polymer or a mixture of polymers, the polymer or at least one of the polymers being a fluoropolymer as defined in the International Application,
   The laminate can also contain a thin layer of a primer between the first layer and the second layer.

International Application No. PCT/US20/66252 also discloses methods of making such two-layer laminates, and the use of such two-layer laminates as windows in 3D printers.

### SUMMARY OF THE INVENTION

If has been found that, if a two-layer laminate as disclosed in International Application No. PCT/US20/66252 is heated to a relatively high temperature, for example to a temperature greater than 80° C., or greater than 90° C. e.g. up to 100° C., during use of the laminate as the window in a 3D printer, the laminate may become distorted. For example, the laminate can develop wrinkles in at least the fluoropolymer layer which provides the upper surface of the window. This is a significant problem, because it is highly desirable that the window remains planar during use of the 3D printer, particularly when the printer is a DLP or SLA printer. The problem can arise, for example, when the resin delivered to the upper surface of the window is an exothermic resin, particularly when the resin is delivered quickly. The present invention provides a solution to this problem.

In a first aspect, this invention provides a laminate comprising
(1) an upper layer which (a) transmits light and (b) is composed of an upper layer polymeric composition, the upper layer polymeric composition being a single polymer or a mixture of polymers, the polymer or at least one of the polymers being a fluoropolymer as hereinafter defined, the upper layer preferably having an oxygen permeability of at least 100 Barrer;
(2) an intermediate layer, having an intermediate layer first surface 102, which (a) adheres to the upper layer, (b) transmits light and (c) is composed of an intermediate layer polymeric composition, the intermediate layer polymeric composition being a single polymer or a mixture of polymers, the polymer or at least one of the polymers preferably being a non-elastomeric polymer and preferably having a glass transition temperature of at least 0° C., for example a PMP polymer as hereinafter defined, and
(3) a lower layer which (a) adheres to an intermediate layer second surface 104, opposite the intermediate layer first surface, (b) transmits light, (c) is composed of a lower layer polymeric composition, and (d) inhibits or prevents distortion of the upper layer when the laminate is heated during its use as the window in a 3D printer, the lower layer polymeric composition being a single polymer or a mixture of polymers. The lower layer preferably has an oxygen permeability of at least 100 Barrer.

The terms “upper layer” and “lower layer” are used herein to assist in the definition of the laminate. As further described below, in one embodiment of the invention, each of the upper and lower layers is composed of a composition which is a single polymer or a mixture of polymers, the polymer or at least one of the polymers being a fluoropolymer as hereinafter defined; in that case either the upper layer or the lower layer can provide the surface to which the resin is delivered. The upper layer polymeric composition and the lower layer polymeric composition can be identical. If the lower layer polymeric composition is not composed of a single polymer or mixture of polymers, the polymer or at least one of the polymers being a fluoropolymer as hereinafter defined, then the upper layer must be the layer to which the resin is delivered in the 3D printer.

The laminate can also include a layer of primer between the upper layer and the intermediate layer and/or between the intermediate layer and the lower layer.

The laminate can also contain other layers which do not have an adverse effect on the performance of the laminate.

In its second aspect, this invention provides apparatus which includes a laminate according to the first aspect of the invention. The apparatus can be a 3D printer for preparing an article having a desired configuration, the apparatus comprising
(1) a photo-polymerizable polymeric composition,
(2) a window, preferably a planar window, having an upper surface and an opposite lower surface,
(3) means for delivering the polymeric composition onto or adjacent to the upper surface of the window, and
(4) means for protecting a pattern of light onto the lower surface of the window, the pattern corresponding to a part of the desired configuration, and the window being transparent to the light,
   whereby, when the apparatus is in operation, the polymeric composition is photo polymerized on or adjacent to the upper surface of the window and forms a part corresponding to a part of the desired configuration;
   wherein the window comprises a laminate according to the first aspect of the invention.

In a third aspect, this invention provides methods of preparing the novel laminate of the first aspect of the invention.

### BRIEF DESCRIPTION OF THE DRAWINGS

The invention is diagrammatically illustrated in the accompanying drawings.

FIG. 1 is a cross-sectional diagrammatic view of a part of a laminate of the invention.

FIG. 2 is an enlarged view of a part of FIG. 1.

FIG. 3 is a cross-sectional diagrammatic view of a 3D printer.

FIG. 4 is a cross-sectional diagrammatic view of a different 3D printer, e.g, a DLP 3D printer; this 3D printer uses a vat which contains a liquid photopolymerizable resin and the bottom of which has a window composed of a transparent, oxygen permeable material.

### DETAILED DESCRIPTION OF THE INVENTION

In the Summary of the Invention above, the Detailed Description of the Invention, the Examples, and the claims below, and the accompanying drawings, reference is made to particular features of the invention. These features can for example be components, ingredients, elements, devices, apparatus, systems, groups, ranges, method steps, test results and instructions, including program instructions.

It is to be understood that the disclosure of the invention in this specification includes all possible combinations of such particular features. For example, where a particular feature is disclosed in the context of a particular aspect or embodiment of the invention, or a particular claim, or a particular Figure, that feature can also be used in combination with and/or in the context of other particular aspects, embodiments, claims and Figures, and in the invention generally, except where the context excludes that possibility.

The invention disclosed herein, and the claims, include embodiments not specifically described herein and can for example make use of features which are not specifically described herein, but which provide functions which are the same, equivalent or similar to, features specifically disclosed herein.

The term “comprises” and grammatical equivalents thereof are used herein to mean that, in addition to the features specifically identified, other features are optionally present. For example, a composition or device “comprising” (or “which comprises”) components A, B and C can contain only components A, B and C, or can contain not only components A, B and C but also one or more other components.

The term “consisting essentially of” and grammatical equivalents thereof is used herein to mean that, in addition to the features specifically identified, other features may be present which do not materially alter the claimed invention.

The term “at least” followed by a number is used herein to denote the start of a range beginning with that number (which may be a range having an upper limit or no upper limit, depending on the variable being defined). For example, “at least 1” means 1 or more than 1, and “at least 80%” means 80% or more than 80%.

The term “at least one of . . . two or more named components” is used herein to denote a single one of the named components or any combination of two or more of the named components.

The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%, When a range is given as “(a first number) to (a second number)” or “(a first number)-(a second number)”, this means a range whose lower limit is the first number and whose upper limit is the second number. For example, “from 8 to 20 carbon atoms” or “8-20 carbon atoms” means a range whose lower limit is 8 carbon atoms, and whose upper limit is 20 carbon atoms. The terms “plural”, “multiple”, “plurality” and “multiplicity” are used herein to denote two or more than two features.

Where reference is made herein to a method comprising two or more defined steps, the defined steps can be carried out in any order or simultaneously (except where the context excludes that possibility), and the method can optionally include one or more other steps which are carried out before any of the defined steps, between two of the defined steps, or after all the defined steps, except where the context excludes that possibility.

Where reference is made herein to “first” and “second” features, this is generally done for identification purposes; unless the context requires otherwise, the first and second features can be the same or different, and reference to a first feature does not mean that a second feature is necessarily present (though it may be present).

Where reference is made herein to “a” or “an” feature, this includes the possibility that there are two or more such features (except where the context excludes that possibility). Thus, there may be a single such feature or a plurality of such features. Where reference is made herein to two or more features, this includes the possibility that the two or more features are replaced by a lesser number or greater number of features which provide the same function, except where the context excludes that possibility.

The numbers given herein should be construed with the latitude appropriate to their context and expression; for example, each number is subject to variation which depends on the accuracy with which it can be measured by methods conventionally used by those skilled in the art at the date of filing of this specification.

The term “and/or” is used herein to mean the presence of the possibilities stated before and after “and/or”. The possibilities can for example be components, ingredients, elements, devices: apparatus, systems, groups, ranges and steps) is present. For example
(i) “item A and/or item B” discloses three possibilities, namely (1) only item A is present, (2) only item B is present, and (3) both item A and Item B are present, and
(ii) “item A and/or item B and/or item C” discloses seven possibilities, namely (1) only item A is present, (2) only item B is present, (3) only item C is present, (4) both item A and item B are present, but item C is not present, (5) both item A and item C are present, but item B is not present, (6) both item B and item C are present, but item A is not present, and (7) all of item A, item B and item C are present.

Where this specification refers to a component “selected from the group consisting of . . . two or more specified sub-components”, the selected component can be a single one of the specified sub-components or a mixture of two or more of the specified sub-components.

If any element in a claim of this specification is considered to be, under the provisions of 35 USC 112, an element in a claim for a combination which is expressed as a means or step for performing a specified function without the recital in the claim of structure, material, or acts in support thereof, and is, therefore, construed to cover the corresponding structure, material, or acts described in the specification and equivalents thereof, then the corresponding structure, material, or acts in question include not only the corresponding structure, material, or acts explicitly described in the specification and the equivalents of such structure, material, or acts, but also such structure, material, or acts described in the US patent documents incorporated by reference herein and the equivalents of such structure, material, or acts. Similarly, if any element (although not specifically using the term “means”) in a claim of this application is correctly construed as equivalent to the term means or step for performing a specified function without the recital in the claim of structure, material, or acts in support thereof, then the corresponding structure, material, or acts in question include not only the corresponding structure, material, or acts explicitly described in the specification and the equivalents of such structure, material, or acts, but also such structure, material, or acts described in the US patent documents incorporated by reference herein and the equivalents of such structure, material, or acts.

This specification incorporates by reference all documents referred to herein and all documents filed concurrently with this specification or filed previously in connection with this application, including but not limited to such documents which are open to public inspection with this specification.

The term “fluoropolymer” is used herein to denote (as in the International Application) an amorphous polymer comprising units derived from a monomer containing at least one fluorinated carbon atom, preferably at least one perfluorinated carbon atom, for example one or more of (i) a monomer which is a perfluorinated ethylenically unsaturated hydrocarbon, for example tetrafluoroethylene, and/or (ii) perfluoro methyl vinyl ether, and/or (iii) monomer(s) containing a perfluorodioxole moiety, including but, not limited to, a perfluoro-1,3-dioxole and/or (iv) a monomer containing a partially fluorinated or perfluorinated dioxolane, dioxolane, dioxane or other 5 or 6 membered heterocyclic ring. Such heterocyclic monomers may contain an exo or endo double bond. The fluoropolymer can be a homopolymer or a copolymer, including polymers which contain units derived from two or more, e.g., three, different monomers, Examples of the monomers that can be used are (i) perfluoro-2,2-dimethyl-1,3-dioxole, (ii) perfluoro-1,3-dioxole, (iii) perfluoro-1,3-dioxolane, (iv) perfluoro-2,2-bis-methyl-1,3-dioxole, (v) 2,2,4-trifluoromethyl-5-trifluoromethoxy-1.3-dioxole, (vi) perfluoro-2-methylene-4-methyl-1,3-dioxolane, (vii) a perfluoro-2,2-dialkyl-1,3-dioxole, (viii) 2.2-bis (trifluoromethyl)-4,5-difluoro-1,3-dioxole, (ix) 2.2-bis (trifluoromethyl)-4-fluoro-5-trifluoromethoxy-1,3-dioxole, and (x) heterocyclic monomers containing one or more 5 or 6 member ring(s). The monomers from which the fluoropolymer can he derived include those disclosed in U.S. Pat. No. 9,643,124 B2 and the references therein. These and other fluoropolymers are disclosed in U.S. Pat. Nos. 4,399,264, 4,935,477, 5,286,283, 5,498,682, 5,008,508, and 9,643,124 B2 the entire contents of which are incorporated herein by reference for all purposes.

Examples of commercially available perfluoropolymers include the products sold under the tradenames Teflon AF 1100, Teflon AF 1300, Teflon AF 2400, Teflon AF 1600 and Hyflon AD.

The term “PMP polymer” is used herein (as in the International Application) to denote a polymer containing units derived from 4-methyl-1-pentene. The PMP polymer preferably comprises at least 80 mol percent, for example about 100 mol percent, of repeating units derived from 4-methyl-1-pentene. The PMP polymer can be a copolymer of 4-methyl-1-pentene and a monomer containing functional units, for example functional units which improve the adhesion of the intermediate layer 12 to the upper layer 11 and lower layer 13 of the laminate or, when the laminate includes one or more layers of a primer, to the primer. Such copolymers are, for example, disclosed in U.S. Pat. No. 7,524,913 (publication No. 2008 0021172), the entire disclosure of which is incorporated herein by reference for all purposes.

Examples of commercially available PMP polymers include those sold under the tradenames MX 004, MX 0020, MX 002, R-18 and DX 485.

### The Upper Layers and Lower Layer of the Laminate.

Each of the upper layer 11 and the lower layer 13 of the laminate is composed of a polymeric composition which comprises a single polymer or a mixture of polymers. The upper layer 11 and the lower layer 13 can be the same or different. For example, the upper layer polymeric composition and the lower layer polymeric composition can be the same or different, and/or the thicknesses of the upper layer 11 and the lower layer 13 can be the same or different.

In one embodiment, each of the upper layer polymeric composition and the lower layer polymeric composition comprises a polymer or a mixture of polymers comprising a fluoropolymer as hereinbefore defined. In that case, the thicknesses of the upper layer 11 and the lower layer 13 are preferably the same or similar so that the laminate remains substantially planar, without wrinkling of either of the fluoropolymer layers, when the laminate is heated when it is used in a 3D printer. In that embodiment, either of the fluoropolymer layers can supply the surface to which a polymeric composition is delivered when the laminate is used in a 3D printer. Thus, the upper layer polymeric composition includes a fluoropolymer while the lower layer polymeric composition comprises a second fluoropolymer.

In other embodiments, the lower layer polymeric composition (a) comprises a polymer or a mixture of polymers which does not comprise a fluoropolymer as hereinbefore defined and (b) preferably has a thickness, such that the lower layer 13 prevents distortion of the upper layer 11 when the laminate is heated when it is used in a 3D printer.

The thickness of each of the upper layer 11 and the lower layer 13 of the laminate is preferably 0.5-500 μm, for example 1-100 μm, e.g. 5-25 μm.

### The Intermediate Layer of the Laminate.

The intermediate layer 12 of the laminate is composed of an intermediate layer polymeric composition, the intermediate layer polymeric composition being a single polymer or a mixture of polymers, the polymer or at least one of the polymers preferably being a non-elastomeric polymer and preferably having a glass transition temperature of at least 0° C. In one embodiment, the intermediate layer polymeric composition comprises a PMP polymer as hereinbefore defined; in this embodiment, the intermediate composition can consist essentially of a homopolymer or copolymer of 4-methyl-pentene. In other embodiments, the intermediate layer 12 is composed of a polymeric composition which does not comprise a PMP polymer, for example a polymeric composition comprising a polyester such as Mylar, poly (2.6-diphenyl-p-phenylene oxide), a CMSM as described by Xiao-Hau, Gas Separation Membranes, Adv Poly. Materials, 2018, a polyacetylene, a para-substituted polystyrene, or a polynorbornene, for example poly (trimethylsilylnorbornene).

The thickness of the intermediate layer 12 can for example be 0.25-5 mil, e.g. 0.75-2 mil. The oxygen permeability of the intermediate layer 12 is preferably at least 10 Barrer.

### Layers of Primer

The laminate optionally comprises a layer of a primer between the upper layer 11 and the intermediate layer 12 and/or a layer of primer between the lower layer 13 and intermediate layer 12. The layer or layers of primer, if present, need not be continuous, but can for example be a series of lines, a pattern of rectangles or a series of drops in a regular or irregular pattern.

The primer is preferably a compound comprising functional groups which can interact with one or both of adjacent layers. Thus, the primer can include a fluorinated portion which promotes adhesion to one of the layers containing a fluoropolymer and/or another portion which promotes adhesion to the intermediate layer 12 of the laminate. The primer compound can for example be a fluoropolymer as defined which contains one or more functional groups, for example a carboxylic group. The presence in the primer of one or more perfluorinated carbon atoms assists adhesion to the second (fluoropolymer) layer, and the presence of suitable functional groups, for example terminal and/or pendant carboxyl groups or phosphate groups, assists adhesion to the intermediate layer 12, which may for example comprise a PMP polymer. Suitable primers include dicarboxy (polyperfluoro-2,3-dimethylene-1-oxolane), a copolymer of perfluoroethylene and perfluoro-2,2-bis-methyl-1,3˜dioxole with terminal and/or pendent carboxylic acid groups or phosphate groups, Fluor a PMP polymer) as a solution in a solvent olink AD1700, Fluorolink phosphate, Fluorolink MD 700 and amide-terminated Fluorolink.

The primer can be applied to a surface of a preformed film of the intermediate layer polymeric composition, for example as a solution of the primer in a solvent which is later completely or almost completely removed, thus creating a thin layer of the primer compound on the surface of the film. The amount of the solvent remaining in the layer of is preferably less than 5%, particularly less than 2%, by weight of the layer of primer. The primer can for example a solution containing be applied as a solution in a fluorinated solvent, e.g. Fluorinert or Novack, the solution containing for example 0.5-5% by weight of the primer. The solution of the primer can be applied in any way, for example by means of an ultrasonic spray nozzle, or manual wiping. The dried layer of primer is very thin and can, for example, have a thickness from about 10 nm to about 5 μm. The layer of primer is very thin and the primer can have an oxygen permeability greater than 10 Barrer, typically greater than 50 Barrer, and in some cases as high as 3000 Barrer.

### Transparency of the Laminate.

Many 3D printers rely upon the photopolymerization of a resin when the resin is exposed to light of a particular wavelength. The wavelengths in current use are about 385 nm, about 405 nm and about 420 nm, but probably other wavelengths will be employed in the future. The laminate should be sufficiently, preferably essentially, transparent to the wavelength used to photopolymerize the resin.

### Methods of Making the Laminates.

One preferred method of making a laminate according to the first aspect of the invention is described here. This method preferably employs both activation of both sides of a preformed film composed of the intermediate layer polymeric composition (for example containing a PMP polymer) and application of the primer solution to both sides of the preformed film. The activation can for example comprise exposing both surfaces of the film to corona etching and/or plasma etching, followed by application of a primer solution to both surfaces of the preformed film while the effect of the activation is still present. A solution of the upper layer polymeric composition (comprising the perfluoro polymer) is coated on a first surface of the preformed film and then heated to remove most of the solvent produce a hard layer of the upper composition on a first surface of the preformed film. After the first surface has been coated and the coating on the preformed film is hard enough to handle, a solution of the lower layer polymeric composition (comprising the perfluoro polymer) is coated on the opposite surface of the preformed film and then heated to remove most of the solvent to produce a hard layer of the lower layer polymeric composition on the second surface. In a final step, the product is placed in a vacuum oven.

In another embodiment, a laminate according to the first aspect of the invention is prepared by the steps of (A) providing a preformed film comprising the intermediate layer polymeric composition; (B) activating both surfaces of the preformed film and/or applying a primer composition to both surfaces of the preformed film; (C) providing two preformed films, one comprising the upper layer polymeric composition and the other comprising the lower layer polymeric composition, and (D) adhering one of the films to one surface of the preformed film and adhering the other of the films to the opposite surface of the preformed film.

In another embodiment, a laminate according to the first aspect of the invention is prepared by providing a preformed film of the intermediate composition, coating a liquid composition comprising the upper layer polymeric composition on one surface of the preformed film and a liquid composition comprising the lower layer polymeric composition on the opposite surface of the preformed film, and solidifying the liquid compositions on the preformed film. Optionally, before the liquid compositions comprising the upper and lower layer polymeric compositions are coated onto the preformed film, one or both surfaces of the preformed film can be activated and/or provided with a liquid primer composition which is dried before the upper and lower layer polymeric liquid compositions.

In another embodiment, the laminate is prepared by a process which comprises the steps of
(A) mounting a roll of a preformed film comprising the intermediate layer polymeric composition in a web coating machine;
(B) subjecting both surfaces of the preformed film to an activation step, followed by coating both surfaces with a liquid primer composition which is subsequently dried;
(C) applying to one surface of the preformed film from step (B) a solution comprising the upper layer polymeric composition, and then drying the solution until it is no longer tacky; and
(D) applying to the opposite surface of the preformed film from step (C) a solution comprising the lower layer polymeric composition, and then drying the solution until it is no longer tacky.
   Steps (C) and (D) can be repeated until a desired thickness of the dried polymeric composition has been achieved. The coated film can thereafter be placed in a vacuum oven and heated to remove any residual solvent.

In another embodiment, the laminate is prepared using an extrusion line capable of co-extruding two or more polymeric compositions. There is one hopper and extrusion barrel for the intermediate layer polymeric composition, and a hopper and extrusion barrel for the each of the upper and lower layer polymeric compositions. Each of the polymeric compositions is loaded into its hopper, and the laminate is extruded with the intermediate layer 12 consisting of the intermediate layer polymeric composition, an upper layer 11 consisting of the upper layer polymeric composition and a lower layer 13 consisting of the lower layer polymeric composition.

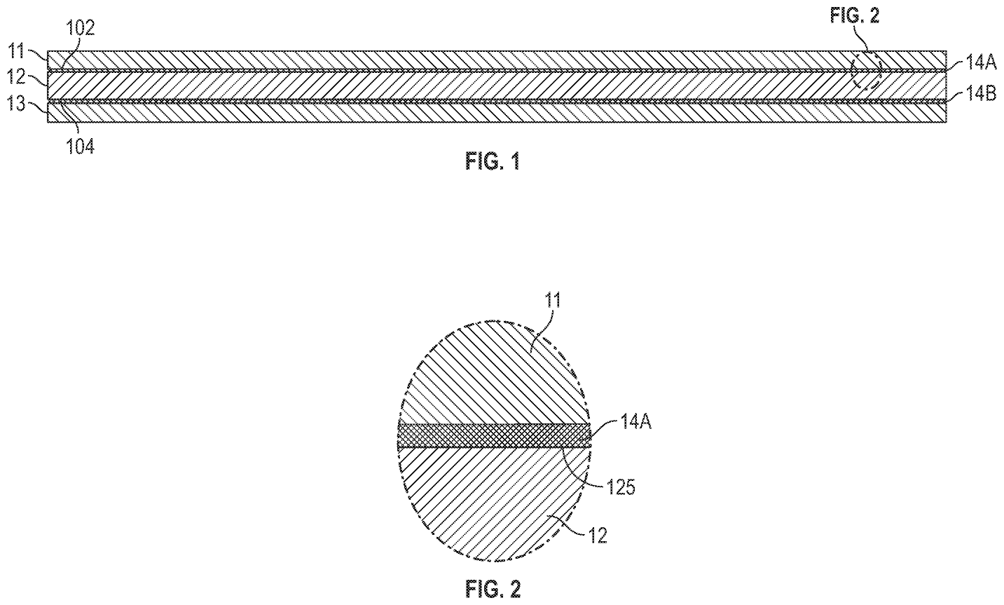

Referring to FIG. 1, a cross-section through a part of a laminate of the invention is provided. The upper layer 11 is made of an amorphous perfluoro polymer with an oxygen permeability of at least 100 Barrer. The intermediate layer 12 is made of a material with an oxygen permeability of at least 10 Barrer. The lower layer 13 is made up of an amorphous perfluoro polymer with an oxygen permeability of at least 10 Barrer, which may be the same or different composition from the upper layer 11. The intermediate layer 12 has an intermediate layer first surface 102 and an intermediate layer second surface 104, the intermediate layer second surface 104 opposite the intermediate layer first surface 102. The intermediate layer first surface 102 is adhered to the upper layer 11 and transmits light. Between the upper layer 11 and the intermediate layer 12 is provided a first primer layer 14A which may have a thickness of 55-100 nm. Between the intermediate layer 12 and the lower layer 13 is provides a second primer layer 14B which may have a thickness of 55-100 nm.

Referring to FIG. 2, an enlarged section of part of FIG. 1 is provided. A first primer layer 14A is provided between the upper layer 11 and the intermediate layer 12. The intermediate layer 12 may include an activated surface 125, which may have a thickness of 3-20 nm.

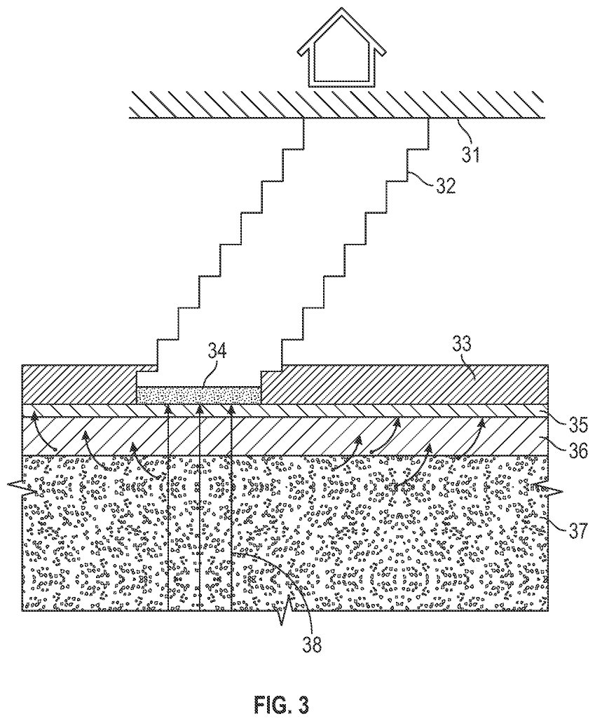

Referring to FIG. 3, a diagrammatic illustration of a 3D printer is provided. Carrier 31 is provided in connection with the three dimensional object 32 being produced from the polymerizable liquid 33 according to the gradient of the polymerization. A dead zone 35 exists during production above the window 36. A polymerization inhibitor 37, through which the radiation 38 is transmitted, is provided below the window 36.

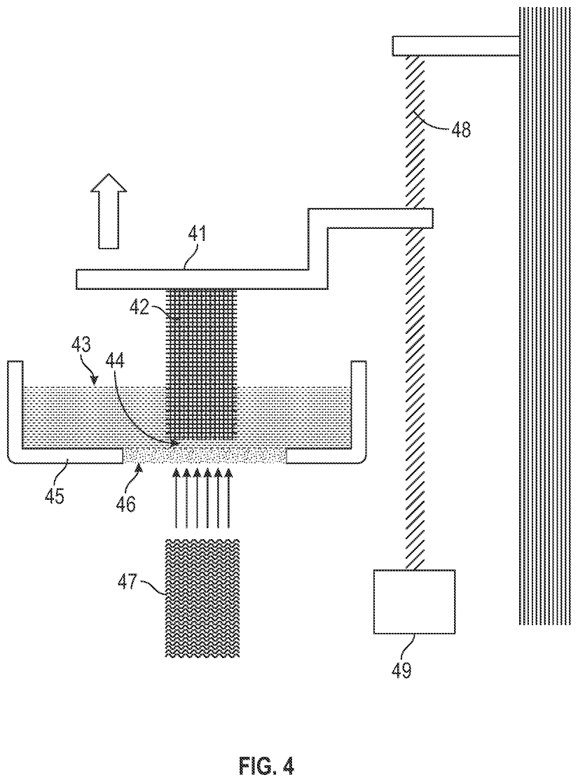

Referring to FIG. 4, a diagrammatic illustration of another 3D printer is provided. The build table 41 is illustrated in connection with the object 42 being produced from the liquid photopolymerizable resin 43 above the dead zone 44 within the resin vat 45 by the pattern provided from the pattern illuminator 47 through the window 46 as the build table 41 is reposition by a vertical lead screw 48 driven by a motor 49.

### 3D Printers Using the Novel Laminates of the First Aspect of the Invention.

The laminates of the first aspect of the invention can be used in any 3D printer to provide the window 36, 46 onto which a polymeric composition is deposited. In some 3D printers, the laminate preferably has permeability to oxygen; but in other 3D printers, the laminate does not need to have (though it can have) permeability to oxygen. The novel laminates are particularly useful in 3D printers in which the window 36, 46 may be heated to a substantial temperature, for example greater than 80° C. or greater than 90ºC, e.g. about 100° ° C. . . . Such heating can arise when the polymeric composition deposited on the window 36, 46 comprises an exothermic resin, for example a resin that generates heat as it cools, e.g. an acrylate resin. Such resins are sometimes used in SLA 3D printers.

### Example 1

Each side of a 1 mil film of poly (4-methyl-1pentene) was treated with a corona etcher and then spray coated, using an ultrasonic sprayer, with a thin layer of a primer in the form of a 1% solution of dicarboxy-(polyperfluoro-2,3-dimethylene-1-oxolane) in Fluorinert FC-40. The oxolane solution was evenly spread over both surfaces of the PMP film and then allowed to dry. The top surface of the PMP film was then coated with a solution of Teflon™ AF2400 in Fluorinert. The resulting product was cured at 80° C. The bottom surface of the PMP film was then coated with a solution of Teflon™ AF2400. The resulting product was first cured at 80° C. and then in vacuo at an elevated temperature. The layers in the resulting film could not be separated by hand.

### Example 2

Each side of a 2 mil film of PMP was corona etched and then spray coated with a thin layer of a solution containing a primer which was a copolymer of perfluoroethylene and perfluoro-2,2-bis˜methyl-1,3-dioxole with terminal and/or pendent carboxylic acid groups. The solution was then allowed to dry. This layer of primer has an oxygen permeability greater than 10 Barrer, typically greater than 50 Barrer, and in some cases as high as 3000 Barrer. The spray-coated layers were dried and one side of the film was then coated with a solution of Teflon™ AF2400. The product was cured at 80° C. The second side of the film was then coated with a solution of Teflon™ AF2400. The product was cured at 80° C. The resulting product was subject to a final cure in vacuo at an elevated temperature. The layers in the resulting film could not be separated by hand. This is an example of using a primer with oxygen permeability greater than 10 Barrer.

### Example 3

Example 2 was repeated, replacing “a copolymer of perfluoroethylene and perfluoro-2,2-bis-methyl-1,3-dioxole with terminal and/or pendent carboxylic acid groups” by a copolymer of perfluoroethylene and perfluoro-2,2-bis-methyl-1,3-dioxole with terminal phosphate groups.

### Example 4

Example 2 was repeated, replacing “a copolymer of perfluoroethylene and perfluoro-2,2-bis-methyl-1,3-dioxole with terminal and/or pendent carboxylic acid groups” by SF60, a polymer produced by Chemours.

### Example 5

Example 2 was repeated, replacing “a copolymer of perfluoroethylene and perfluoro-2,2-bis-methyl-1,3-dioxole with terminal and/or pendent carboxylic acid groups” by EVE-P, a monomer produced by Chemours.

### Example 6

A laminate prepared as described in Example 2 was mounted in the tray of a 3D printer. A number of 3D prints were made and it was observed that there was no apparent difference in the 3D prints made with a monolithic Teflon™ AF2400 film and those made with the laminate prepared according to Example 2. The printer speed, resolution, and pull forces were the same when a monolithic Teflon™ AF2400 film was used and when the laminate prepared according to Example 2 was used.

### Example 7

A laminate prepared as described in Example 2 was mounted in the tray of a different 3D printer. A number of 3D prints were made and it was observed that there was no apparent difference in the 3D prints made with a monolithic Teflon™ AF2400 film and those made with the laminate prepared according to Example 2. The printer speed, resolution, and pull forces were the same when a monolithic Teflon™ AF2400 film was used and when the laminate prepared according to Example 2 was used.

### Example 8

Each side of a polyester film is corona etched and then spray coated with a thin layer of dicarboxy-(polyperfluoro-2,3-dimethylene-1-oxacyclopentane). The spray coated layer is then allowed to dry. The upper and lower sides of the product are then sequentially coated with a solution of Teflon™ AF2400. Each side of the film was cured at 80° C. the resulting product was cured in vacuo at an elevated temperature. The layers in the resulting film are found to be adhered to each other so strongly that they could not be separated by hand. This is an example of making a film that does not have oxygen permeability of at least 10 Barrer.

### Additional Information about the Invention Follows

This invention addresses the need for light transmissive, oxygen permeable, materials to be used in the tray or build area (also known as the build plate or build assembly) of several types of 3D printers. It also addresses the need for light transmissive materials to be used in the tray or build area of a 3D printer that requires non-stick properties but may not require oxygen. In both cases the light transmissive laminate of this invention consists of at least three layers in which at least the upper layer 11, and preferably both the upper layer 11 and the lower layer 13, is composed of a light transmissive amorphous fluoropolymer and the intermediate layer 12 consists of a light transmissive material which is a non-elastomeric material preferably having a glass transition temperature equal to or higher than 0° C. The types of 3D printers that can have their performance increased by the use of these laminates include, but are not limited to, DLP (3D printers based on a digital light projector or digital light processor), DLV (3D printers based on a digital light valve), CLIP 3D printers, SLA 3D printers and other 3D printers.

Some 3D printers operate on the basis of a light source that launches light through a transparent build area (also known as the build plate or build assembly), usually a transparent area of the tray that holds the resin that will form the part, and said light triggers a chemical polymerization in the resin according to the pattern of the light that is launched. Typically, there is a moving stage (a carrier 31) that moves vertically away from the build area as the part is being generated. If the transparent build area has a non-stick surface such as a perfluoropolymer, the part will have greatly reduced adhesion to the build area. In addition, if the transparent build area is oxygen permeable then, with some resins, the polymerization will be quenched in a narrow region between the part that is being built and the build area. In this case the part being built and the build area never come in contact and there is no adhesion between the 3D part and the build area. For example, see U.S. Pat. Nos. 9,636,873, 10,016,938 and 9,211,678, the entire contents of which are incorporated by reference herein for all purposes. As described in U.S. Pat. No. 9,636,873, the method is:
“A method of forming a three-dimensional object, is carried out by (a) providing a carrier and a build plate, the build plate comprising a semipermeable member, the semipermeable member comprising a build surface with the build surface and the carrier defining a build region there between, and with the build surface in fluid communication by way of the semipermeable member with a source of polymerization inhibitor; (b) filling the build region with a polymerizable liquid, the polymerizable liquid contacting the build surface, (c) irradiating the build region through the build plate to produce a solid polymerized region in the build region, while forming or maintaining a liquid film release layer comprised of the polymerizable liquid formed between the solid polymerized region and the build surface, wherein the polymerization of which liquid film is inhibited by the polymerization inhibitor; and (d) advancing the carrier with the polymerized region adhered thereto away from the build surface on the build plate to create a subsequent build region between the polymerized region and the build surface while concurrently filling the subsequent build region with polymerizable liquid as in step (b).
   The use of an exemplary laminate of the invention in 3D printers is illustrated by way of example in the Figures below.

### REFERRING NOW TO THE DRAWINGS

FIG. 1 is a cross-section through a part of a laminate of the invention. In FIG. 1. the reference numerals denote
11 is the upper layer, which is made of an amorphous perfluoro polymer with an oxygen permeability of at least 100 Barrer;
12 is the intermediate layer which is made up of a material with an oxygen permeability of at least 10 Barrer;
13 is the lower layer which is made up of an amorphous perfluoro polymer with an oxygen permeability of at least 10 Barrer and is the same as or different from the upper layer 11; and
14A and 14B are intermediate primer layers, each having for example a thickness of 55-100 nm.

FIG. 2 is an enlarged section of part of FIG. 1. In FIG. 2 the reference numerals denote
11 is the upper layer;
12 is the intermediate layer; and
14A is the primer layer between the upper layer 11 and the intermediate layer 12;
125 denotes the activated surface of the intermediate layer 12. The activated surface may for example have a thickness of 3-20 nm.

FIG. 3 is a diagrammatic illustration of a 3D printer. In FIG. 3 the reference numerals denote
31 is the carrier;
32 is the three-dimensional object being produced;
33 is the polymerizable liquid for the 3D object being produced;
34 is the gradient of polymerization;
35 is the dead zone;
36 is the window in the resin vat;
37 is the polymerization inhibitor; and
38 is the radiation.

FIG. 4 is a diagrammatic illustration of another 3D printer. In FIG. 4 the reference numerals denote
41 is the build table;
42 is the object being produced;
43 is the liquid photopolymerizable resin;
44 is the dead zone;
45 is the resin vat;
46 is the window in the resin vat;
47 is the pattern illuminator; and
48 is a vertical lead screw driven by a motor 49.

1. A laminate, comprising
an upper layer (11),
the upper layer (11) being light transmissive,
the upper layer (11) is composed of an upper layer polymeric composition,
the upper layer polymeric composition being selected from an upper layer polymeric composition group consisting of a first single polymer and a first mixture of a plurality of polymers,
wherein the single polymer is a fluoropolymer, and
wherein at least one polymer of the plurality of polymers of the first mixture of a plurality of polymers is a fluoropolymer;
an intermediate layer (12),
the intermediate layer (12) being light transmissive,
the intermediate layer (12) having an intermediate layer first surface (102) and an intermediate layer second surface (104), the intermediate layer second surface (104) opposite the intermediate layer first surface (102),
the intermediate layer first surface (102) adhered adheres to the upper layer (11);
(c) the intermediate layer (12) composed of an intermediate layer polymeric composition,
the intermediate layer polymeric composition being non-elastomeric and having a glass transition temperature of at least 0° C.,
the intermediate layer polymeric composition being selected from an intermediate layer polymeric composition group consisting of a second single polymer or a second mixture of a plurality of polymers; and
a lower layer (13),
the lower layer (13) being light transmissive,
the lower layer (13) adhered to the intermediate layer second surface,
the lower layer (13) composed of a lower layer polymeric composition,
the lower layer polymeric composition being selected from a lower layer polymeric composition group consisting of a third single polymer and a third mixture of a plurality of polymers,
the lower layer (13) configured to inhibit a distortion of the upper layer (11) when the upper layer (11) has a temperature of about 100 C.

2. The laminate of claim 1 wherein the lower layer polymeric composition comprises a second fluoropolymer.

3. The laminate of claim 2 wherein one of the fluoropolymer and the second fluoropolymer is tetrafluoroethylene.

4. The laminate of claim 2 wherein
the upper layer polymeric composition and the lower layer polymeric composition are identical,
the upper layer (11) has an oxygen permeability of at least 100 Barrer, and
the lower layer (13) has an oxygen permeability of at least 10 Barrer.

5. (canceled)

6. The laminate of claim 3 wherein the intermediate layer polymeric composition comprises a polymethylpentene polymer.

7. The laminate according to of claim 6 further comprising a first primer layer (14A) between the upper layer (11) and the intermediate layer (12) and a second primer layer (14B) between the intermediate layer (12) and the lower layer (13).

8. (canceled)

9. (canceled)

10. (canceled)

11. (canceled)

12. (canceled)

13. (canceled)

14. (canceled)

15. The laminate of according to claim 2 wherein
the upper layer polymeric composition and the lower layer polymeric composition are tetrafluoroethylene,
the upper layer (11) has an oxygen permeability of at least 100 Barrer, and
the lower layer (13) has an oxygen permeability of at least 100 Barrer.

16. The laminate of claim 14 further comprising a first primer layer (14A) between the upper layer (11) and the intermediate layer (12) and a second primer layer (14B) between the intermediate layer (12) and the lower layer (13).
